(19) United States
(12) Patent Application Publication
(10) Pub. No.: US 2010/0108617 A1
(43) Pub. Date: May 6, 2010

(54) Stormwater filtration system

(76) Inventors: Peter W. Schmidt, Virginia Beach, VA (US); Dornton Kirk Edens, Suffolk, VA (US)

Correspondence Address: Kaufman & Canoles c/o Kelly Brown, P.O. Box 3037, Norfolk, VA, 23514-3037, US

(21) Appl. No.: 12/386,474

(22) Filed: Apr. 17, 2009

Related U.S. Application Data
(60) Provisional application No. 61/124,994, filed on Apr. 21, 2008.

(51) Int. Cl. B01D 39/02; E03F 1/00; C02F 1/00

(52) U.S. Cl. 210/768; 210/170.03; 210/807

(57) ABSTRACT

A novel method to filter stormwater in existing and new facilities. The system is generally an insert or series of inserts which include lightweight aggregate (“LWA”) in a manner such that the aggregate is retained in the insert. The insert includes openings to allow water to flow into the insert and through the LWA such that contaminants are captured by the aggregate and removed from the water which exits the insert.

### CROSS REFERENCE TO RELATED APPLICATION

The present application claims priority from U.S. Provisional Application Ser. No. 61/124,994, filed Apr. 21, 2008.

### BACKGROUND OF THE INVENTION

1. Field of the Invention

The present invention relates to a stormwater treatment method, and, more particularly to a storm water treatment method which employs reusable materials to filter stormwater.

2. Description of Related Art

Generally, treatment of stormwater to remove pollutants dates back only to the early 1990's with the advent of regulations such as the Chesapeake Bay Preservation Act and the adoption of Stormwater Ordinances by local governments. Because of these new regulatory initiatives, permitting requirements now called for treatment before discharge of stormwater in any new developments, typically utilizing some form of Best Management Practice (“BMP”), usually a stormwater detention pond. Notwithstanding these steps, by far, the bulk of stormwater that fell prior to such regulations and which still falls today in any municipality, flows untreated though the existing stormwater system into rivers, bays, estuaries, and finally to the ocean. This is due to the fact that the majority of our cities already had constructed stormwater collection infrastructure prior to 1990, and there was no regulatory requirement to retrofit existing facilities.

Promulgation of the Clean Water Act resulted in permit issuance for virtually every “end-of-pipe” situation, so that the chief source of pollutants flowing into our waters today comes from “non-point” sources, or stormwater runoff from cities, farms, and commercial and industrial sites. Permitting agencies at the national and state level now are focusing very closely on the reduction of non-point source pollution. These mandates will only become more rigorous as the regulatory bar is raised to reduce pollutant levels.

The most common prior art device for stormwater treatment typically used in BMPs for new construction is a stormwater pond. Such ponds are not used for infrastructure that was built before the early 1990's when stormwater ordinances came into effect mandating BMP's for all new construction. In the case of Virginia Beach, Va., for example, only 17% of the water that falls in the land area that flows to the Lynnhaven River is currently treated before it reaches the Lynnhaven estuary. Obviously, this untreated flow contributes disproportionately to stormwater pollution.

There are numerous applications for technology which can treat a much higher portion of stormwater.

An object of the present invention is to provide a stormwater treatment method and apparatus.

An object of the present invention is to provide a stormwater treatment method and apparatus which can treat a large portion of stormwater.

An object of the present invention is to provide a stormwater treatment method and apparatus which can be retrofit into existing facilities.

Another object of the present invention is to provide a stormwater treatment method and apparatus which can be used in new facilities.

Yet another object of the present invention is to provide a stormwater treatment method and apparatus which benefits from reusable materials.

Finally, it is an object of the present invention to accomplish the foregoing objectives in a simple and cost effective manner.

### SUMMARY OF THE INVENTION

The present invention addresses these needs by providing a device for filtering contaminants from stormwater. The device has an insert which has openings to allow flow through of stormwater and contaminants contained therein and an amount of aggregate material placed within the insert such that the aggregate is retained therein while stormwater flows through the aggregate material. The insert is preferably constructed from a rigid water resistant material. The aggregate material is preferably placed in a mesh bag or a mesh pocket which is placed within the insert. In a particularly preferred embodiment, the device includes a water direction element for directing stormwater into the insert and through the aggregate.

A method for filtering contaminants from stormwater using this apparatus is also described. The insert described above is placed within a sewer system such that stormwater flows through the aggregate material within the insert and contaminants are collected by the aggregate material from the stormwater. Once the aggregate has collected contaminants from the stormwater, it is removed from the sewer system, and replaced with a second insert containing fresh aggregate material. In a particularly preferred embodiment, upon removal of the insert, debris, such as recyclables, organic matter, dirt and residuals, is removed from the sewer system. Such debris may then be treated by sorting and selling of recyclables, composting vegetative matter, reselling common dirt as fill, and taking the residuals to an appropriate landfill. The aggregate material in the removed insert may be treated to remove the contaminants such that the aggregate material may be reused.

### BRIEF DESCRIPTION OF THE DRAWINGS

A more complete description of the subject matter of the present invention and the advantages thereof, can be achieved by the reference to the following detailed description by which reference is made to the accompanying drawings in which:

FIG. 1 shows a perspective cutaway drawing of an insert box according to the preferred embodiment of the present invention;

FIG. 2 shows an installed insert box according to the preferred embodiment of the present invention;

FIG. 3a shows an alternate embodiment for installing a filtration medium according to the preferred embodiment of the present invention;

FIG. 3b shows an alternate embodiment for installing a filtration medium according to the preferred embodiment of the present invention;

FIG. 4 shows an installed stack of insert boxes according to the preferred embodiment of the present invention;

FIG. 5 shows an installed stack of insert boxes according to the preferred embodiment of the present invention;

FIG. 6 shows a method for directing stormwater according to the preferred embodiment of the present invention; and

FIG. 7 shows a method for directing stormwater according to the preferred embodiment of the present invention.

### ELEMENT LIST

12 light weight aggregate
14 insert
16 top of insert
18 hole
20 screen mesh
22 filtration layer
24 porous material
26 mesh pocket
28 mesh bag
30 hose
32 water direction device
34 exit hole

### DETAILED DESCRIPTION OF THE PREFERRED EMBODIMENT

The following detailed description is of the best presently contemplated mode of carrying out the invention. This description is not to be taken in a limiting sense, but is made merely for the purpose of illustrating general principles of embodiments of the invention.

The new technology presented here is centered around a system which can be placed in existing facilities and which can be included in new construction. Generally, an insert or series of inserts includes lightweight aggregate (“LWA”) in a manner such that the aggregate is retained in the insert. The insert includes openings to allow water to flow into the insert and through the aggregate such that contaminants are captured by the aggregate and removed from the water which exits the insert.

The typical use of LWA is as a raw material in the manufacturing of lightweight block, lightweight concrete, or as fill material to span an area where poor soils exist and a road is being built over them. Besides being lighter in weight, LWA provides better fire ratings, better sound absorption, and savings from the manufacturer being able to deliver more product on a given vehicle because of the lower weight of the finished product.

The lower unit weight of raw material also allows a lesser amount to be used to achieve the same volume of aggregate as compared to normal weight aggregates in formulations of concrete mixes, often resulting in material cost savings as well. Gradation of LWA will vary to meet specific sizing requirements in different product areas.

In addition to its valuable properties as a raw material in construction, LWA has a unique ability to physically remove pollutants from stormwater because of its physical structure. Porous openings allow non-dissolved pollutant particles to lodge in the porous cells, remaining there until the LWA is cleaned through various treatment trains. Gradation issues are important in the use of LWA to remove pollutants from stormwater, as residence time for stormwater as it passes through the insert in the storm drain is a vital part of effective pollutant removal. For that reason, specific gradation measures are taken to allow the greatest amount of residence time while enabling reasonable flow rates to be able to fully receive the first flush before bypass occurs.

Pollutants commonly found in stormwater are total suspended solids (TSS), nutrients (nitrogen and phosphorous), heavy metals (cadmium, chromium, copper, lead, nickel, zinc), oil and grease and fecal coliform.

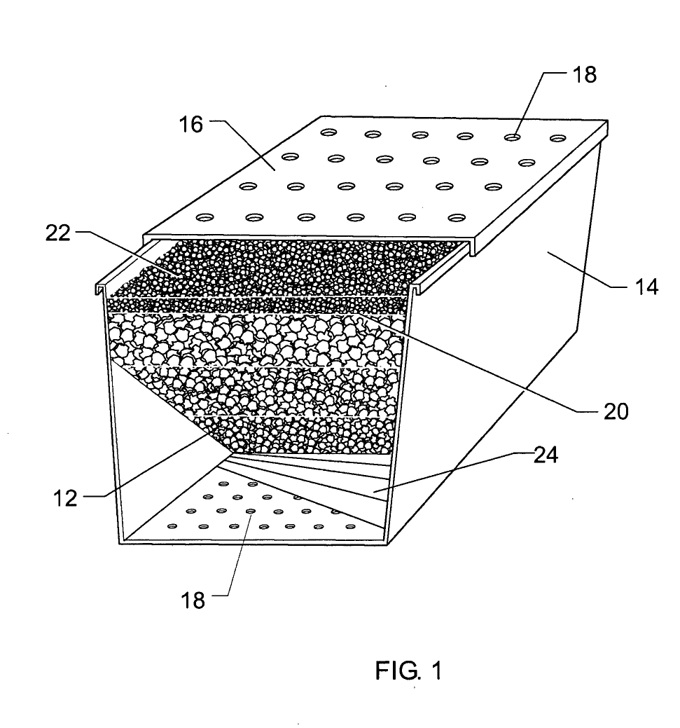

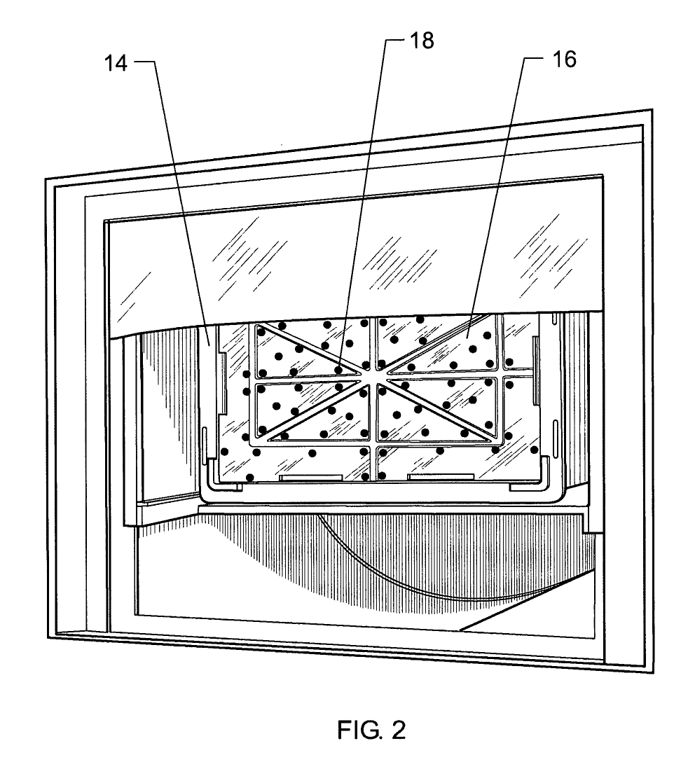

It is the intent of this invention to utilize loose light weight aggregate (“LWA”) 12 by placing it in an insert 14, which then is placed into a storm drain as shown in FIG. 2. As shown in FIG. 1, the preferred embodiment of the present invention is to use LWA 12 in a stacked insert 14 system with an indented top covering 16 which includes holes 18 to allow flow through of storm water. The bottom of the insert 14 also includes holes 18 to allow the stormwater to exit the insert after pollutants have been removed. Within the top covering 16 of the insert 14 is a layer of #8-#100 sized mesh 20 which keeps LWA 12 from floating out of the insert 14 as it is inundated with stormwater. For additional filtration of large debris, a layer of gravel 22 or other similar sized particles may be used. To prevent LWA 12 from exiting with the stormwater, the bottom of the insert 14 is covered with a porous material 24 such as cheesecloth. The insert 14 is formed from a rugged material suitable for use in water. In that there are a variety of storm drains with different configurations, there is no set shape for the insert 14, other that it contains sufficient LWA 12 to provide adequate treatment of stormwater flow.

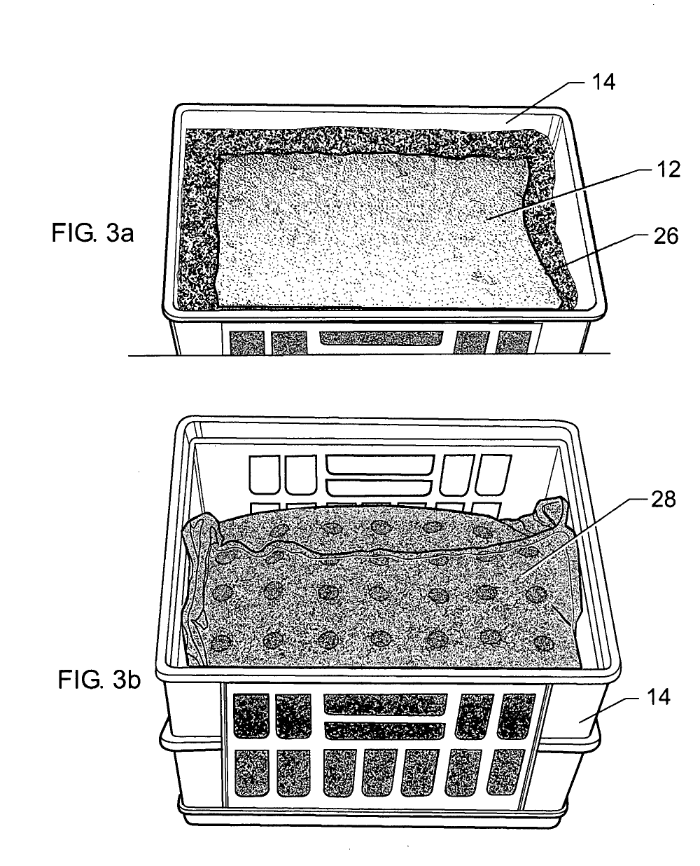

In alternate embodiments of the present invention, the LWA 12 may be placed into an open top mesh pocket 26 (FIG. 3a) or a closed mesh bag 28 (FIG. 3b). The mesh pocket 26 or mesh bag 28 is made from a material which is porous but which is has a fine enough mesh to retain the LWA 12.

In use, a storm drain is engineered to capture a certain amount of flow from the first flush. This is predicated on the amount of land the drain must service as well as the desired depth of first flow treatment. Thus, the insert 14 must allow flow-through of water and pollutants such that the pollutants are allowed to come in contact with and be collected by the LWA 12 within the insert 14. The insert 14 may flexible or rigid so long as the first flush of stormwater passes through the insert 14, which is sized to accommodate this initial flow, and which typically contains the greatest amount of pollutants. As the storm event grows and the flow of stormwater exceeds the first flush, the insert 14 is designed to allow bypass of this cleaner water directly to the exit point of the storm drain. Thus, the LWA 12 in the insert 14 captures and removes the most noxious pollutants.

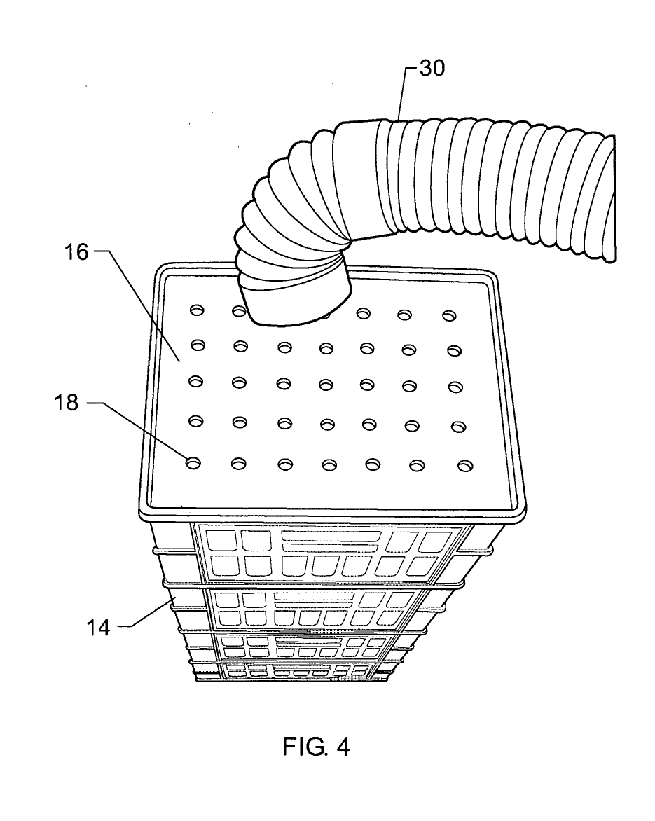

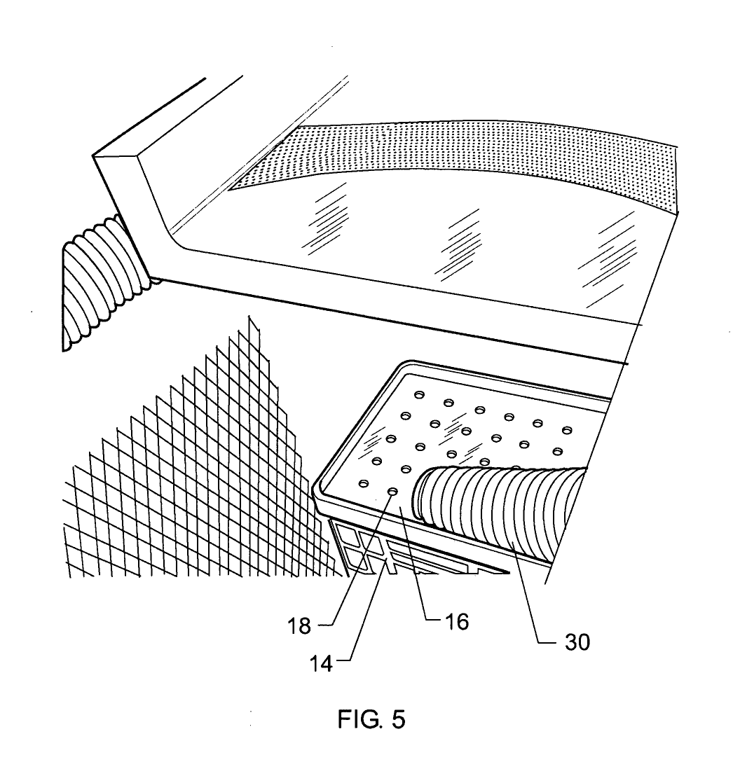

FIGS. 4 and 5 show a preferred structure for use of the present invention. In this exemplary system, mesh bags 28 which are filled with LWA 12 are placed into three inserts 14. Each insert includes a top 16 having multiple holes 18 to allow stormwater to enter. The inserts 14 are then stacked within the sewer system as shown. The stormwater flows onto the top 16 of the insert 14, falls through the holes 18, passes through the mesh bag 28 and then comes in contact with the LWA 12. Pollutants gather in the LWA 12 allowing filtered water to pass through the bottom of each insert 14. Allowing the stormwater to flow through the stack of inserts 14 provides optimal filtration.

Different methods are available for causing stormwater to flow into the inserts 14. FIGS. 4 and 5 show one such method. In this method, stormwater flowing into the sewer opening is directed into a hose 30. The stormwater flows through the hose 30 and exits the hose at the top of the stack of inserts 14.

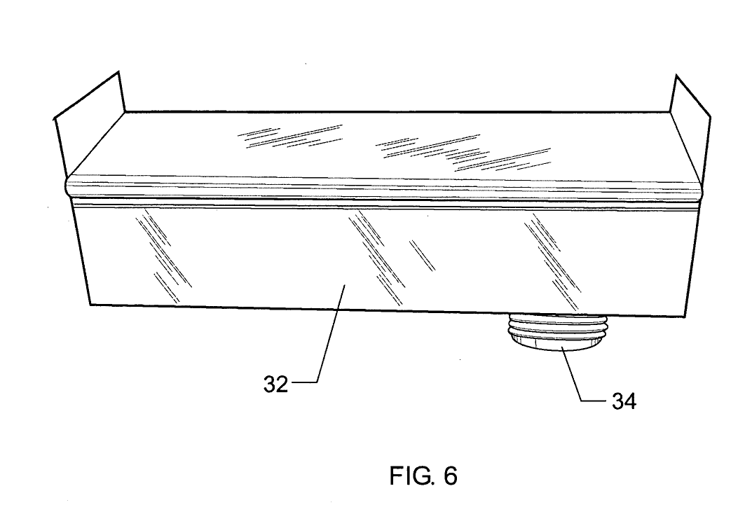

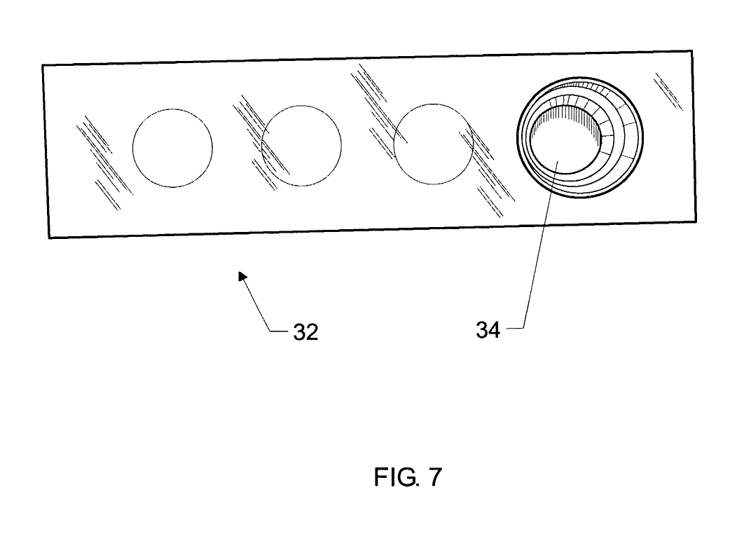

FIGS. 6 and 7 show a device for directing stormwater to the top of stacked inserts 14. The device 32 is placed within the sewer opening at street level. Stormwater enters the device 32 and flows through an exit hole 34 in the bottom of the device 32 which leads into the hose 30.

Once sufficient storm events have taken place for the LWA 12 to reach breakthrough such that it is no longer capable of efficiently removing pollutants from stormwater, the spent inserts 14 are removed and replaced with inserts 14 with fresh LWA 12. The spent LWA 12 material may then be treated as described below such that it may then be used to replace spent LWA 12 material.

The spent inserts 14 are then preferably brought back to a central treatment facility, where various treatment methods are employed to remove captured pollutants from LWA 12 so it can be reused. Pollutants which are removed from the LWA 12 include heavy metals, fecal coliform, oil and grease, non-dissolved nutrients, and organics. A variety of treatments may be utilized: For metals treatment, tanks with mild acid solutions may be used to precipitate metals from the LWA 12, piles of LWA 12 may be treated with bacteria which consume oil and grease, or a rotary kiln may be employed to destroy organics and oil and grease by exposure to heat. Once the LWA 12 is cleaned to a certain standard, we also can blend some of it with topsoil to sell as a landscaping mix—the porous and water-retaining LWA 12 assures that moisture is maintained in the mix. Landscapers often blend LWA 12 with soil to use as an effective growing medium. Other treatment methods and uses of the treated LWA are possible. Another choice may be to entomb the LWA in concrete block and bypass some or all of the remediation steps.

A particularly preferred step in this method is to clean out the curb inlets when they are serviced, removing all debris—sand, cans, bags, etc. This debris may then be brought to a treatment facility, to allow sorting and selling of recyclables, composting vegetative matter, reselling common dirt as fill, and taking the residuals to an appropriate landfill.

The current invention is a significant improvement over the prior art allowing treatment of stormwater by servicing the existing environment, from which a significant and constant portion of stormwater pollution will always come unless something like this is done. Prior art does not employ the simplified method of servicing the aggregate once its absorption qualities have been depleted.

Furthermore, while we have described use of this invention to treat stormwater, such description is exemplary in nature and is not to be seen as limiting. Use of this invention is not restricted to treatment of stormwater. The LWA containing inserts can be used to treat other water such as drinking water and waste water from sanitary sewers. Additional possible treatment sites include (a) upon entering and/or leaving residences and businesses, (b) sewer lines, (c) upon entering or leaving water treatment plants and waste water treatment plants and/or (d) wells.

In an alternate embodiment of the present invention, the nature of this invention relates to removal of pollutants from stormwater during new construction. The physical removal process is the same as with inserts, as is the treatment methodology for spent LWA. What is different is the application, because we are not retrofitting a storm drain in the “built” environment; rather, we are constructing precast concrete box(es) that hold LWA and are sized to receive the “first flush” for the required treatment area.

As new roads are constructed, at the edge of the roadway a section of curb and gutter is built using ready mixed concrete placed into forms. At its bottom the rounded curb meets a roughly 12″ wide section of concrete gutter extending into the roadway up to the edge of asphalt or concrete pavement. This “gutter pan” is angled slightly towards the edge of the street, away from the center of the roadway. This slight inclination and the crowning of the street towards the outside, forces stormwater to flow towards the curb and be carried down the gutter pan to the storm drain. The curb and gutter also has a slight fall to move water to the storm drain over however many linear feet of roadway the storm drain is designed to receive stormwater flow.

Our invention allows modular insertion of sections of precast concrete boxes, in the place of the gutter pan, with open steel grates on the top, to receive this stormwater flow as it moves towards the storm drain, filtering and removing pollutants and allowing clean water to flow through a tube at the bottom of the box into the storm drain.

As the storm event picks up in intensity and the velocity of flow exceeds the first flush, water simply will pass over the grate, as the underlying LWA is saturated with stormwater, and will enter the mouth of the storm drain. This is the bypass mechanism built into the invention. All of the initial flow, or first flush, the box(es) are designed to treat, will flow down the concrete gutter and through the grate into the LWA below (once the stormwater reaches a receiving box), for subsequent pollutant removal. If a larger footprint of area needs to be treated, additional boxes are simply installed end to end, providing more treatment area to receive stormwater flow. Through a pipe flowing from one box into the next, these modular sections allow treated water to flow into the storm drain.

When the device needs to be serviced, the grates simply are removed and the LWA insert is lifted out and taken to a treatment facility for treatment, with fresh inserts put in the place of spent material. The device may have a set of baffles at the bottom to enhance sediment deposition, which is cleaned out with a vacuum truck when the inserts are changed. The exit pipe from the storm drain is covered with wire to assure no gross trash or vegetative waste flows down the pipe into our waterways.

An important facet of this invention is the fact that no BMP taking valuable land needs to be constructed. The box is the BMP. This saves the municipality land and construction funding and particularly relates to an infill situation in an area of the city where there is insufficient land to build the BMP. As well, as BMP's are seldom if ever serviced and sediments escape into our waterways as ponds fill up because they are not cleaned out when full, the service component of the invention keeps our waterways as pristine as possible.

With respect to the type of LWA which is appropriate for use in this invention, there are various types.

Naturally occurring through volcanic explosions, as in pumice, scoria, tuff, lava rock, perlite (which can be expanded by addition of heat). Domestic pumice is found in the western United States and trades under names such as: Hess, Copar, CR Minerals, Glass Mountain, California Lightweight, Cascade and Sierra Cascade. Foreign sources include LWA from Greece, Italy, Turkey, Germany, Canary Islands, Azores, Monserrat, Martinique, and Mexico.

Expanded shales, slates, and clays. These aggregates are created through the expansion of the above-referenced type of rock by feeding them through a rotary kiln at temperatures from 1800-2400 degrees F. As the rock moves through the kiln, expanded gases escape from the rock, changing its physical configuration by bloating it and creating porous cells, which results in lower weights and greater porosity to the resulting product. Well-known names of these products and/or their domestic manufacturers include Solite, Stalite, Norlite, Haydite, Kenlite, Livlite, Gravelite, Arkalite, Utelite, Buildex, and Themo Lite. Expanded products manufactured in other countries include Liapor, Leca and Argex.

Coal combustion byproducts, as in the bottom ash that is remaining after coal is burned in an industrial utility or power plant setting. Bottom ash is a coarse, granular LWA that typically has the same physical characteristics and low unit weight as naturally occurring LWA and expanded LWA.

Manufactured, like “zonolite”, an expanded vermiculite. Perlite is a naturally occurring material that can be expanded through the addition of heat. Fly ash is a coal combustion byproduct that is very fine and can be formed into LWA through some means of agglomeration, like pelletization or extrusion. Typically, there also is added a binding agent like cement, scrubber sludge, or cement kiln dust. The resulting LWA is either cold-bonded or can be cured with the addition of some form of heat. Typical ash-based LWA includes Versalite, Aardelite, PFA, and Lytag.

Filtration Test

A local river, the Lynnhaven River was selected for testing. Because the Lynnhaven River fails state requirements for contaminants, namely fecals, it was considered a good beta test site.

A series of 14 tests were conducted by an independent laboratory to determine the filtering capability of the instant invention.

The mixture of contaminants developed to create a controlled artificial stormwater was devised after analyzing stormwater collected behind a shopping mall flowing into a finger of a local creak. In order to standardize the mixture, all of the metals were added at the highest level detected in the creek sample. In doing this, most of the metals in the mixture are 6 to 50 times more concentrated than in the actual stormwater sample.

| | Creek | Laboratory |
|---|---|---|
| | Stormwater Sample | mixture |
| Cadmium | non-detect | 0.5 mg/L |
| Chromium | 0.009 mg/L | 0.5 mg/L |
| Copper | 0/084 mg/L | 0.5 mg/L |
| Lead | 0.016 mg/L | 0.5 mg/L |
| Nickel | 0.010 mg/L | 0.5 mg/L |
| Zinc | 0.489 mg/L | 0.5 mg/L |
| TSS | 109 mg/L | 100 mg/L |
| Oil and Grease | non-detect | 50 mg/L |
| Fecal Coli form | Sample expired | 275 CFU/100 mL |

The following is a synopsis of the test results:

Metals

| | | |
|---|---|---|
| Cadmium | 86.1% average removal | (range 56.9 to 95.6%) |
| Chromium | 97.4% average removal | (range 92.3 to 100%)* |
| Copper | 94.2% average removal | (range 80.0 to 100%)* |
| Lead | 98.0% average removal | (range 93.7 to 100%)* |
| Nickel | 77.6% average removal | (range 51.0 to 88.3%) |
| Zinc | 90.0% average removal | (range 71.0 to 97.9%) |
| Total Suspended | 87.05 average removal | (range 72.0 to 100%)* |
| Solids (TSS) | | |
| Fecal Coli form | 99.3% average removal | (range 97.8 to 100%)* |
| Oil and Grease | 100% average removal* | |

*Note: Tests indicating 100% removal mean that any contaminant left after filtration was below the detection ability of the laboratory's equipment.

Obviously, many modifications may be made without departing from the basic spirit of the present invention. Accordingly, it will be appreciated by those skilled in the art that within the scope of the appended claims, the inventions may be practiced other than has been specifically described herein. Many improvements, modifications, and additions will be apparent to the skilled artisan without departing from the spirit and scope of the present invention as described herein and defined in the following claims.

What is claimed is:

1. A device for filtering contaminants from stormwater, comprising:
an insert having openings to allow flow through of stormwater and contaminants contained therein; and
an amount of aggregate material placed within the insert such that the aggregate is retained therein while stormwater flows therethrough.

2. The device as set forth in claim 1 wherein the insert is constructed from a rigid water resistant material.

3. The device as set forth in claim 1 wherein the aggregate material is placed in a mesh bag which is placed within the insert.

4. The device as set forth in claim 1 wherein the aggregate material is placed in a mesh pocket which is placed within the insert.

5. The device as set forth in claim 1 further comprising:
a water direction element for directing stormwater into the insert and through the aggregate.

6. A method for filtering contaminants from stormwater, comprising:
providing an insert having openings to allow flow through of stormwater and contaminants contained therein;
placing an amount of aggregate material within the insert such that the aggregate is retained therein while stormwater flows therethrough;
placing the insert within a sewer system such that stormwater flows through the aggregate material within the insert and contaminants are collected by the aggregate material from the stormwater;
once the aggregate has collected contaminants from the stormwater, removing the insert from the sewer system; and
replacing the insert with a second insert containing fresh aggregate material.

7. The method as set forth in claim 6 wherein the insert is constructed from a rigid water resistant material.

8. The method as set forth in claim 6 wherein the aggregate material is placed in a mesh bag which is placed within the insert.

9. The method as set forth in claim 6 wherein the aggregate material is placed in a mesh pocket which is placed within the insert.

10. The method as set forth in claim 6 further comprising:
placing a water direction element within the sewer system for directing stormwater into the insert and through the aggregate.

11. The method as set forth in claim 6 further comprising:
upon removal of the insert, removing debris from the sewer system.

12. The method as set forth in claim 11 further comprising:
following removal of the insert, wherein the debris consists of elements selected from the group consisting of recyclables, organic matter, dirt and residuals, treating the debris by the following steps:
a. sorting and selling of recyclables,
b. composting vegetative matter,
c. reselling common dirt as fill, and
d. taking the residuals to an appropriate landfill.

13. The method as set forth in claim 6 further comprising:
following removal of the insert, treating the aggregate material to remove the contaminants.
